(19) United States
(12) Patent Application Publication
(10) Pub. No.: US 2017/0066460 A1
(43) Pub. Date: Mar. 9, 2017

(54) SIMULATION AND EXPERIMENT PLATFORM FOR HIGH-SPEED TRAIN BRAKING SYSTEM AND EXPERIMENT METHOD

(71) Applicant: CRRC QINGDAO SIFANG CO., LTD., Qingdao, Shandong (CN)

(72) Inventors: Junchao ZHOU, Qingdao, Shandong (CN); Long HAN, Qingdao, Shandong (CN); Hongju CUI, Qingdao, Shandong (CN); Jiangang CAO, Qingdao, Shandong (CN); Zhilin ZHAO, Qingdao, Shandong (CN)

(73) Assignee: CRRC QINGDAO SIFANG CO., LTD., Qingdao, Shandong (CN)

(21) Appl. No.: 15/119,366

(22) PCT Filed: Oct. 28, 2015
(86) PCT No.: PCT/CN2015/093037

§ 371 Date: Aug. 16, 2016

(30) Foreign Application Priority Data
Nov. 25, 2014 (CN) 201410687699.3

(51) Int. Cl. B61L 27/00; G06F 17/50; G01M 17/08

(52) U.S. Cl. CPC B61L 27/0055; G01M 17/08; G06F 17/5009; G06F 17/5095

(57) ABSTRACT

A simulation platform for a high-speed train braking system and an experiment method. The simulation platform for a high-speed train braking system includes a virtual part and a real part. The virtual part includes: a vehicle multi-rigid-body simulation system, a basic braking simulation system, a dynamic braking simulation system, an additional braking simulation system, and a virtual reality terminal. The real part includes: a simulated cab, a braking control apparatus, an air braking system, a wheel-rail adhesion simulation system, and a data collection and conversion interface. The virtual part and the real part perform information exchange by using the data collection and conversion interface.

This application claims priority to Chinese Patent Application No. 201410687699.3 titled “SIMULATION EXPERIMENT PLATFORM AND METHOD FOR HIGH-SPEED TRAIN BRAKE SYSTEM” and filed with the Chinese State Intellectual Property Office on Nov. 25, 2014, which is incorporated herein by reference in its entirety.

### FIELD

The present disclosure relates to the technical field of simulation, and in particular to a simulation platform and an experiment method for a high-speed train brake system.

### BACKGROUND

A brake system, which serves as a key subsystem of a high-speed train (for example, high-speed multiple-unit), is critical to life and property safety of passengers and the railway system. A running speed for a high-speed train is generally above 200 km/h, and is even higher for a high-speed multiple-unit in a track test. Since kinetic energy of a moving object is proportional to a square of a speed thereof, increase of the speed means that braking energy required by a train to brake increases dramatically, and also means that the actual track test for a train brake system is becoming more and more dangerous.

In addition, in the actual track test, it is very difficult and costs massive manpower and material resources to change parameters to be researched in brake experiments based on experiment requirements, such as a friction coefficient of a brake shoe, a running resistance of a train and a wheel-rail adhesion,.

### SUMMARY

The object of the present disclosure is to provide a simulation platform and an experiment method for a high-speed train brake system to improve safety of experiments and reduce costs of the experiments.

To achieve the above object, following technical solutions are provided according to embodiments of the present disclosure.

A simulation platform for a high-speed train brake system is provided. The simulation platform includes a physical part and a virtual part.

The physical part includes a simulated cab, a brake control apparatus connected to the simulated cab, an air brake system connected to the brake control apparatus, a wheel-rail adhesion simulation system and a data collecting and converting interface connected to the air brake system and the wheel-rail adhesion simulation system.

The virtual part includes a vehicle multi-rigid-body simulation system, and a bogie brake simulation system, a dynamic brake simulation system, an additional brake simulation system and a virtual reality terminal which are connected to the vehicle multi-rigid-body simulation system.

The vehicle multi-rigid-body simulation system is configured to simulate motion and dynamic status of a train in a brake process. The simulation at least includes braking distance, braking retardation, longitudinal dynamic status of the train, a rotational speed of a wheel set, and a wheel-rail relation under different brake conditions.

The bogie brake simulation system is configured to simulate a brake disc. The simulation at least includes application of a braking force on the brake disc, a temperature, a stress and a strain of the braking disc, and a friction coefficient between the braking disc and a brake shoe.

The dynamic brake simulation system is configured to simulate a dynamic brake process. The simulation at least includes a braking force provided by the dynamic brake system in a brake process, antiskid control, a running resistance of the train, and relations between dynamic braking and other braking modes.

The additional brake simulation system is configured to simulate a brake process of air dynamic brake or eddy current brake, and a braking effect of the air dynamic brake or the eddy current brake.

The virtual reality terminal is configured to display an operating process and an operating result of the simulation platform for a high-speed train brake system.

Information exchange is conducted between the physical part and the virtual part through the data collecting and converting interface.

Preferably, in the above-described simulation platform for the high-speed train brake system, the simulated cab, the brake control apparatus, the air brake system and the wheel-rail adhesion simulation system are simulated with physical objects of 1:1 scale.

Preferably, in the above-described simulation platform for the high-speed train brake system, the wheel-rail adhesion simulation system is simulated with a single wheel.

Preferably, in the above-described simulation platform for the high-speed train brake system, the wheel-rail adhesion simulation system includes:
a rail wheel, a rail wheel drive subsystem, a wheel, a wheel drive subsystem, a hydraulic loading subsystem and an environment simulation subsystem.

Preferably, in the above-described simulation platform for the high-speed train brake system, the simulated cab is connected to the brake control apparatus through at least one of a train network and a train hard wire.

A simulation method for a high-speed train brake system, applied to the above-described simulation platform for the high-speed train brake system, is provided. The simulation method includes:
sending, by the simulated cab, a braking command to the brake control apparatus;
sending, by the vehicle multi-rigid-body simulation system, vehicle speed information to the brake control apparatus through the data collecting and converting interface, where the vehicle speed information includes a rotational speed of a wheel set;
performing, by the brake control apparatus, an analytical calculation in response to the braking command, an adhesion coefficient obtained in advance, and the vehicle speed information, obtaining a control command corresponding to the braking command and the vehicle speed information, and controlling the air brake system in response to the control command;
inputting parameter information outputted by the physical part into the simulation systems in the virtual part through the data collecting and converting interface;
performing, by the simulation systems, analyzing, calculating and simulating on the parameter information generated by the physical part, and feeding back a result to the components of the physical part; and
displaying, by the virtual reality terminal, the operating process and the operating result of the simulation platform for the high-speed train brake system.

According to the solutions above, a simulation platform and an experiment method for a high-speed train brake system are provided according to the embodiments of the present disclosure. The simulation platform for the high-speed train brake system includes a physical part and a virtual part. The virtual part includes a vehicle multi-rigid-body simulation system, a bogie brake simulation system connected to the vehicle multi-rigid-body simulation system, a dynamic brake simulation system, an additional brake simulation system and a virtual reality terminal. The physical part includes a simulated cab, a brake control apparatus connected to the simulated cab, an air brake system connected to the brake control apparatus, a wheel-rail adhesion simulation system, and a data collecting and converting interface connected to the brake control apparatus and the wheel-rail adhesion simulation system. Information exchange is conducted between the virtual part and the physical part through the data collecting and converting interface. In the simulation platform for the high-speed train brake system according to the embodiments of the present disclosure, an entire brake process on a track is truly reappeared through a hardware-in-loop simulation with the high-speed train brake control apparatus, without an experiment of a train on a real track, where experiment parameters such as a friction coefficient of a brake shoe and a running resistance of a train can be changed with a simulation system, and wheel-rail adhesion can be changed with a wheel-rail adhesion system, thereby improving safety of experiments and reducing costs of the experiments.

### BRIEF DESCRIPTION OF THE DRAWINGS

The drawings to be used in the description of the embodiments or conventional technology are described briefly hereinafter, such that technical solutions according to the embodiments of the disclosure or in conventional technology may become clearer. Apparently, the drawings in the following description only illustrate some embodiments of the disclosure. For those skilled in the art, other drawings may be obtained based on these drawings without any creative work.

FIG. 1 is a structural diagram of a simulation platform for a high-speed train brake system according to an embodiment of the disclosure; and

FIG. 2 is a structural diagram of a wheel-rail adhesion simulation system according to an embodiment of the invention.

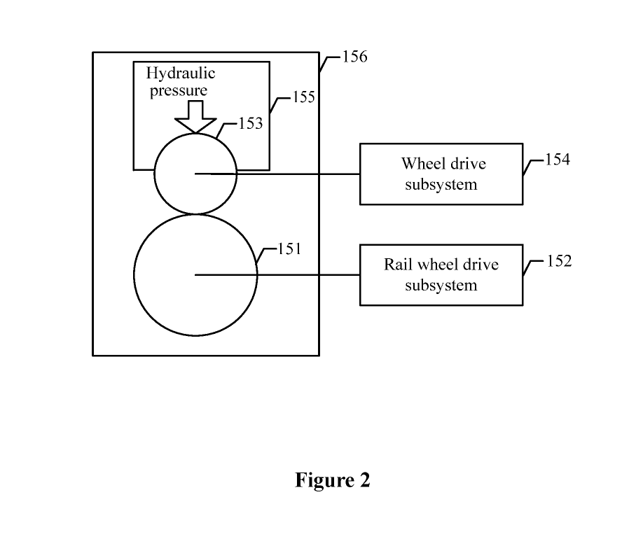

### DETAILED DESCRIPTION

Technical solutions according to embodiments of the disclosure are described clearly and completely hereinafter in conjunction with the drawings. Apparently, the described embodiments are only a few rather than all of the embodiments of the disclosure. Any other embodiments obtained by those skilled in the art based on the embodiments according to the present disclosure without any creative work fall in the scope of the disclosure.

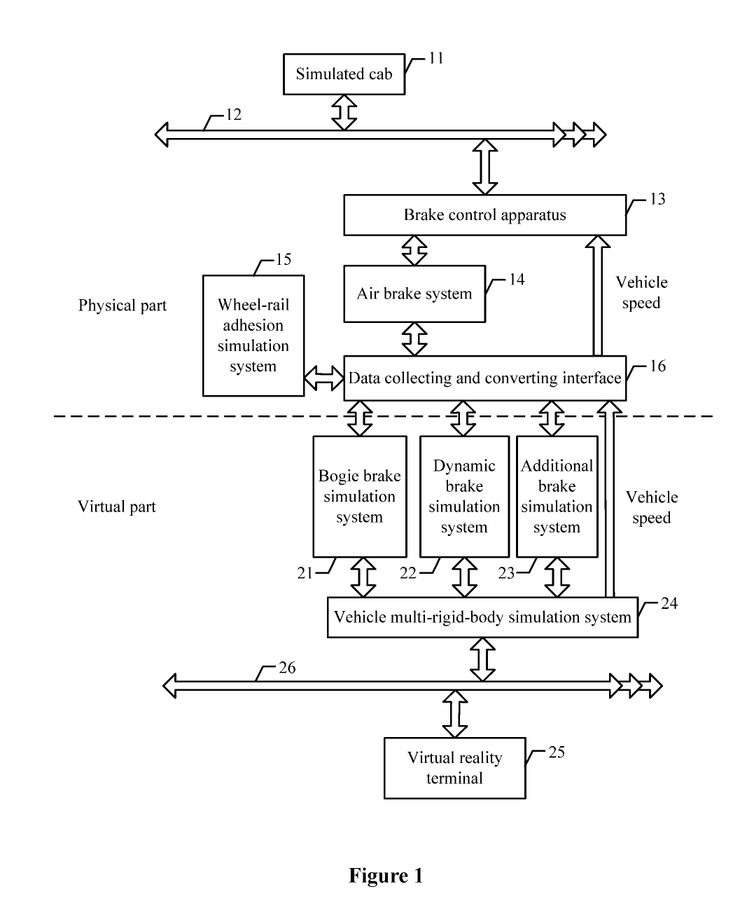

Reference is made to FIG. 1, which is a structural diagram of a simulation platform for a high-speed train brake system according to an embodiment of the invention. The simulation platform includes a physical part and a virtual part.

The physical part includes a simulated cab 11, a brake control apparatus 13 connected to the simulated cab 11, an air brake system 14 connected to the brake control apparatus 13, a wheel-rail adhesion simulation system 15, and a data collecting and converting interface 16 connected to the air brake system 14 and the wheel-rail adhesion simulation system 15.

The wheel-rail adhesion simulation system 15 is configured to simulate status of relative motion between a wheel and a rail under different environmental operating conditions, to calculate wheel-rail adhesion coefficients under different environmental operating conditions.

The virtual part can perform simulations with a simulation computer. The virtual part may include a bogie brake simulation system 21, a dynamic brake simulation system 22, an additional brake simulation system 23, a multi-rigid-body simulation system 24 and a virtual reality terminal 25. The bogie brake simulation system 21, the dynamic brake simulation system 22, the additional brake simulation system 23 and the virtual reality terminal 25 are connected to the vehicle multi-rigid-body simulation system 24.

The bogie brake simulation system 21 is configured to simulate a brake disc. The simulation at least includes application of a braking force on the brake disc, a temperature, a stress and a strain of the braking disc, and a friction coefficient between the braking disc and a brake shoe.

The dynamic brake simulation system 22 is configured to simulate a dynamic brake process. The simulation at least includes a braking force provided by the dynamic brake system in a brake process, antiskid control, a running resistance of the train and relations between the dynamic brake and other brake modes.

The additional brake simulation system 23 is configured to simulate a brake process of air dynamic brake or eddy current brake, and to simulate a braking effect of the air dynamic brake or the eddy current brake.

The vehicle multi-rigid-body simulation system 24 is configured to simulate motion and dynamic status of a train in a brake process. The simulation at least includes braking distance, braking retardation, longitudinal dynamic status of the train, a rotational speed of a wheel set and a wheel-rail relation under different brake conditions.

The virtual reality terminal 25 is configured to display an operating process and an operating result of the simulation platform for the high-speed train brake system.

Information exchange is conducted between the physical part and the virtual part through the data collecting and converting interface 16.

In the simulation platform for the high-speed train brake system according to the embodiment of the disclosure, an entire brake process on a track is truly reappeared through a hardware-in-loop simulation with a high-speed train brake control apparatus, without an experiment of a train on a real track. Experiment parameters such as a friction coefficient of a brake shoe and a running resistance of a train can be changed with a simulation system, and wheel-rail adhesion can be changed with a wheel-rail adhesion system, thereby improving safety of experiments and reducing costs of the experiments.

Optionally, to improve an effect of reality of a simulation experiment, in an embodiment of the disclosure, the simulated cab 11, the brake control apparatus 13, the air brake system 14 and the wheel-rail adhesion simulation system 15 are simulated with physical objects of 1:1 scale. For example, the air brake system may be a physical prototype in a high-speed train, and a performance of the high-speed train brake system may reappear, so as to facilitate analyzing and optimizing the air brake system, analyzing a cooperation effect of electric-controlled brake, and starting authentication of a systematic digital prototype in the future.

Optionally, the wheel-rail adhesion simulation system 15 may be simulated with a single wheel.

Optionally, the wheel-rail adhesion simulation system 15 may include:
a rail wheel 151, a rail wheel drive subsystem 152, a wheel 153, a wheel drive subsystem 154, a hydraulic loading subsystem 155 and an environment simulation subsystem 156.

The rail wheel 151 is configured to simulate a rail.

The hydraulic loading subsystem 155 is configured to pressurize the wheel 153, to simulate a pressure from a carriage on the wheel 153.

The environment simulation subsystem 156 is configured to simulate environment information, such as temperature, rain, snow, wind and sand.

The wheel-rail simulation system transfers parameters of different environmental operating conditions, and speeds of the rail wheel and the wheel under different environmental operating conditions to the simulation systems in the virtual part, and the simulation systems in the virtual part calculate adhesion coefficients based on the parameters of the environmental operating conditions and based on the speeds of the rail wheel and the wheel under corresponding environmental operating conditions, and feed the adhesion coefficients back to the wheel-rail adhesion system.

In the above embodiment, optionally, the simulated cab 11 and the brake control apparatus 13 may be connected to each other through at least one of a train network and a train hard wire 12, to exchange information.

In the embodiment of the disclosure, the simulated cab 11 and the brake control apparatus 13 may communicate with each other only through the train network, only through the train hard wire, or through a combination of the train network and the train hard wire.

It should be noted that, structures for communications with other components are reserved in each component of the physical part, information can be exchanged between the components of the physical part through at least one of the train network and the train hard wire 12 consequently, but corresponding connections are not shown in FIG. 1. For example, information may be exchanged between the simulated cab 11 and the data collecting and converting interface 16 through at least one of the train network and the train hard wire 12, and information may be exchanged between the wheel-rail adhesion simulation system 15 and the brake control apparatus 13 through at least one of the train network and the train hard wire 12.

The simulation platform for the high-speed train brake system according to the embodiment of the disclosure may be applied to a multi-car-marshalling train, such as a 16-car-marshalling or an 8-car-marshalling train. In a case of an n-car-marshalling train (n is an integer greater than 1), an overall brake system for the n-car-marshalling train can be formed with n combined simulation platforms for the high-speed train brake system according to the embodiment of the disclosure. Of course, in the n simulation platforms for the high-speed train brake system, only a physical part of a simulation platform for a brake system of a carriage corresponding to a driver control cab has a simulated cab, while the other carriages do not have the simulated cab.

Based on the above-described simulation platform for the high-speed train brake system, a experiment method for a high-speed train brake system is further provided in the present disclosure. The method may include steps S31 to S35.

In step S31, the simulated cab sends a braking command to the brake control apparatus.

The braking command may include, but is not limited to, a common braking command, a quick braking command or an emergency braking command.

A tester operates the simulated cab, such that the simulated cab can send the braking command to the brake control apparatus.

In step S32, the vehicle multi-rigid-body simulation system sends vehicle speed information to the brake control apparatus through the data collecting and converting interface.

The vehicle speed information is obtained by the vehicle multi-rigid-body simulation system through a calculation based on simulated information (including braking distance, braking retardation, longitudinal dynamic status of the train, a rotational speed of a wheel set and a wheel-rail relation under different brake conditions).

In step S33, the brake control apparatus performs an analytical calculation based on the braking command, an adhesion coefficient obtained in advance and the vehicle speed information, obtains a control command corresponding to the braking command and the vehicle speed information, and controls the air brake system in response to the control command.

In step S34, parameter information outputted by the physical part is inputted into the simulation systems in the virtual part through the data collecting and converting interface, and the simulation systems and the vehicle multi-rigid-body simulation system perform analyzing, calculating and simulating on the parameter information generated by the physical part, and feed back a result to the components of the physical part, i.e., the simulated cab, the brake control apparatus, the air brake system and the wheel-rail adhesion simulation system.

Parameters outputted by the physical part may include the braking command sent from the simulated cab, an electrical braking force request sent from the brake control apparatus, data obtained by the brake control apparatus through calculations on feedback information sent by the virtual part in response to the electrical braking force request, and air spring pressure, overall wind pressure and brake cylinder pressure which are sent by the air brake system.

In step S35, the virtual reality terminal displays an operating process and an operating result of the simulation platform for the high-speed train brake system.

In one aspect, the virtual reality terminal reproduces a simulation process in a physical form, simulates scene changes (such as changes of rain, snow, wind, sand and temperature) of a brake process by means of virtual reality and simulated driving, and monitors moving components of the brake system in the simulation process, such as image monitoring on the air brake system and image monitoring on the wheel-rail adhesion simulation system. In the other aspect, the virtual reality terminal synchronously displays related technical parameters of the brake system in the simulation process, such as comparison of pressure curves of brake cylinders in the brake process. Those skilled in the art shall appreciate that illustrative units and steps of algorithms according to the embodiments of the present disclosure may be implemented through electronic hardware or a combination of computer software and electronic hardware. Whether those functions are implemented through hardware or software depends on specific applications and design limitations of the technical solutions. Professionals in the art may implement the described functions by different methods for each specific application, and such an implementation should not be interpreted as going beyond the scope of the present disclosure.

It should be understood that, the system and the method according to the embodiments of the present disclosure may be implemented in other ways. For example, the system embodiments described above are illustrative only. For example, the apparatus is divided merely based on logical functions, and may be divided in other ways in practical implementations. For example, some apparatuses or components may be combined with each other or integrated into another system, or some features may be ignored or not implemented. In addition, the displayed or discussed mutual couplings, direct couplings, or communication connections may be indirect couplings or communication connections implemented through some interfaces and devices, which may be electronic, mechanical or in other forms.

In addition, each of the control apparatuses according to the embodiments of the present disclosure may be integrated into one processing unit, or may be separate physical existence, or two or more thereof may be integrated into one unit.

The above description of the embodiments of the disclosure allows those skilled in the art to realize or use the disclosure. Numerous modifications made to the embodiments are apparent to those skilled in the art, and general principles defined in the present disclosure can be implemented in other embodiments without deviating from technical essential or scope of the present disclosure. Thus, the disclosure is not limited to the embodiments of the present disclosure, but falls within the widest scope consistent with principles and novelties provided in the disclosure.

1. A simulation platform for a high-speed train brake system, comprising a physical part and a virtual part, wherein
the physical part comprises a simulated cab, a brake control apparatus connected to the simulated cab, an air brake system connected to the brake control apparatus, a wheel-rail adhesion simulation system, and a data collecting and converting interface connected to the air brake system and the wheel-rail adhesion simulation system; and
the virtual part comprises a vehicle multi-rigid-body simulation system, and a bogie brake simulation system, a dynamic brake simulation system, an additional brake simulation system and a virtual reality terminal which are connected to the vehicle multi-rigid-body simulation system; wherein
the vehicle multi-rigid-body simulation system is configured to simulate motion and dynamic status of a train in a brake process, at least comprising braking distance, braking retardation, longitudinal dynamic status of the train, a rotational speed of a wheel set, and a wheel-rail relation under different brake conditions;
the bogie brake simulation system is configured to simulate a brake disc, at least comprising application of a braking force on the brake disc, a temperature, a stress and a strain of the braking disc, and a friction coefficient between the braking disc and a brake shoe;
the dynamic brake simulation system is configured to simulate a dynamic brake process, at least comprising a braking force provided by the dynamic brake system in a brake process, antiskid control, a running resistance of the train, and relations between dynamic braking and other braking modes;
the additional brake simulation system is configured to simulate a brake process of air dynamic brake or eddy current brake, and a braking effect of the air dynamic brake or the eddy current brake;
the virtual reality terminal is configured to display an operating process and an operating result of the simulation platform for a high-speed train brake system, and information exchange is conducted between the physical part and the virtual part through the data collecting and converting interface.

2. The simulation platform for the high-speed train brake system according to claim 1, wherein the simulated cab, the brake control apparatus, the air brake system and the wheel-rail adhesion simulation system are simulated with physical objects of 1:1 scale.

3. The simulation platform for the high-speed train brake system according to claim 1, wherein the wheel-rail adhesion simulation system is simulated with a single wheel.

4. The simulation platform for the high-speed train brake system according to claim 3, wherein the wheel-rail adhesion simulation system comprises:
a rail wheel, a rail wheel drive subsystem, a wheel, a wheel drive subsystem, a hydraulic loading subsystem and an environment simulation subsystem.

5. The simulation platform for the high-speed train brake system according to claim 1, wherein the simulated cab is connected to the brake control apparatus through at least one of a train network and a train hard wire.

6. A simulation method for a high-speed train brake system, applied to the simulation platform for the high-speed train brake system according to claim 1, the method comprising:
sending, by the simulated cab, a braking command to the brake control apparatus;
sending, by the vehicle multi-rigid-body simulation system, vehicle speed information to the brake control apparatus through the data collecting and converting interface, wherein the vehicle speed information comprises a rotational speed of a wheel set;
performing, by the brake control apparatus, an analytical calculation in response to the braking command, an adhesion coefficient obtained in advance, and the vehicle speed information, obtaining a control command corresponding to the braking command and the vehicle speed information, and controlling the air brake system in response to the control command;
inputting parameter information outputted by the physical part into the simulation systems in the virtual part through the data collecting and converting interface;
performing, by the simulation systems, analyzing, calculating and simulating on the parameter information generated by the physical part, and feeding back a result to the components of the physical part; and
displaying, by the virtual reality terminal, the operating process and the operating result of the simulation platform for the high-speed train brake system.
